(19) United States
(12) Patent Application Publication
(10) Pub. No.: US 2024/0423268 A1
(43) Pub. Date: Dec. 26, 2024

(54) AEROSOL GENERATING DEVICE

(71) Applicant: KT&G CORPORATION, Daejeon (KR)

(72) Inventors: Hee Gun PARK, Sejong (KR); Dong Sung KIM, Seoul (KR); Hyung Jin BAE, Daejeon (KR); Jang Heun YEUM, Seoul (KR); Geon Chang LEE, Daejeon (KR); Hae Jin LIM, Seongnam-si (KR)

(73) Assignee: KT&G CORPORATION, Daejeon (KR)

(21) Appl. No.: 18/274,603

(22) PCT Filed: Apr. 3, 2023
(86) PCT No.: PCT/KR2023/004416

§ 371 Date: Jul. 27, 2023

(30) Foreign Application Priority Data
Apr. 5, 2022 (KR) 10-2022-0042432

(51) Int. Cl. A24F 40/40; A24F 40/20; A24F 40/51; A24F 40/53; A24F 40/65

(52) U.S. Cl. CPC A24F 40/40; A24F 40/20; A24F 40/51; A24F 40/53; A24F 40/65

(57) ABSTRACT

According to various embodiments, an aerosol generating device includes a plurality of pad units, each including a first end surface, a second end surface formed an opposite side of the first end surface, a front surface formed between the first end surface and the second end surface, and a rear surface formed on an opposite side of the front surface, a heating unit disposed on the front surface of each of the plurality of pad units, and a hinge unit disposed between the plurality of pad units, wherein the aerosol generating device is transformable such that the front surface of each of the plurality of pad units faces toward a central axis.

### TECHNICAL FIELD

The following embodiments relate to an aerosol generating device.

### BACKGROUND ART

Recently, demands for alternative ways to overcome disadvantages of general cigarettes have increased. For example, there is an increasing demand for a device (e.g., an electrically heated tobacco product) that generates an aerosol by electrically heating a cigarette stick. Accordingly, research on an electrically heated aerosol generating device and a cigarette stick (or an aerosol generating article) applied thereto is being actively conducted. For example, Korean Patent Publication No. 10-2017-0132823 discloses a non-combustion type flavor inhaler, a flavor inhalation component source unit, and an atomizing unit.

### DISCLOSURE OF THE INVENTION

### Technical Goals

An aspect provides an aerosol generating device that may be stored in a flat shape when not in use and may be transformed (rolled) to have a three-dimensional shape and used, thereby increasing user convenience.

An aspect provides an aerosol generating device that is easy to store and carry and improves aesthetics.

### Technical Solutions

According to various embodiments, an aerosol generating device may include a plurality of pad units, each including a first end surface, a second end surface formed on an opposite side of the first end surface, a front surface formed between the first end surface and the second end surface, and a rear surface formed on an opposite side of the front surface, a heating unit disposed on the front surface of each of the plurality of pad units, and a hinge unit disposed between the plurality of pad units, wherein the aerosol generating device may be transformable such that the front surface of each of the plurality of pad units faces toward a central axis.

In an embodiment, the aerosol generating device may include a spread mode in which the plurality of pad units are disposed side by side on the same plane and a rolling mode in which the front surface of each of the plurality of pad units faces toward the central axis, wherein the aerosol generating device may be activated in the rolling mode, and the aerosol generating device may be deactivated in the spread mode.

In an embodiment, in the rolling mode, the aerosol generating device may be transformed such that the front surface of each of the plurality of pad units faces toward the central axis and form an elongated cavity configured to accommodate an aerosol generating article.

In an embodiment, the heating unit may include a heating portion configured to generate heat and a cover configured to cover and uncover the heating portion, wherein the cover opens as the aerosol generating article is inserted into the elongated cavity.

In an embodiment, the cover of the heating unit may be disposed parallel to the front surface of each of the plurality of pad units, and the cover opens as the aerosol generating article pushes the cover on the front surface of each of the plurality of pad units while being inserted into the elongated cavity.

In an embodiment, the heating unit may have an arch structure such that the elongated cavity has a cylindrical shape in the rolling mode.

In an embodiment, the plurality of pad units may each further include a side surface formed between the first end surface and the second end surface and between the front surface and the rear surface, and the side surface may be disposed to be adjacent to another side surface between the plurality of pad units.

In an embodiment, the plurality of pad units may include edge pad units respectively disposed at both edges and at least one center pad unit disposed between the edge pad units, wherein the edge pad units each may include a magnetic body disposed on the side surface, and the edge pad units may be coupled to each other by an attractive force of the magnetic body as the aerosol generating device is transformed such that the front surface of each of the plurality of pad units faces toward the central axis.

In an embodiment, the side surface of the edge pad units may include a first side surface disposed adjacent to the center pad unit and a second side surface disposed to be spaced apart from the center pad unit, wherein an angle between the second side surface and the front surface may be an obtuse angle.

In an embodiment, the second side surface of each of the edge pad units may face each other and be in close contact with each other such that the front surface of each of the plurality of pad units is disposed to face toward the central axis.

In an embodiment, the aerosol generating device may further include a battery disposed in at least one of the plurality of pad units and configured to supply power to the aerosol generating device.

In an embodiment, the aerosol generating device may further include a heat insulating member disposed adjacent to the rear surface of each of the plurality of pad units, wherein the heat insulating member may prevent heat generated in the heating unit from being transferred to the rear surface of each of the plurality of pad units.

In an embodiment, the hinge unit may be configured to connect the plurality of pad units to each other and may include a first hinge unit disposed parallel to the first end surface of each of the plurality of pad units and a second hinge unit disposed parallel to the second surface.

### Effects

According to an embodiment, an aerosol generating device may be stored in a flat shape when not in use and may be transformed (rolled) to have a three-dimensional shape and used, thereby increasing user convenience.

According to an embodiment, an aerosol generating device is easy to store and carry and may improve aesthetics.

The effects of the aerosol generating device and the aerosol generating system according to an embodiment are not limited to the above-mentioned effects, and other unmentioned effects may be clearly understood from the following description by one of ordinary skill in the art.

### BRIEF DESCRIPTION OF DRAWINGS

FIG. 1 is a block diagram of an aerosol generating device according to an embodiment.

FIGS. 2a and 2b are diagrams illustrating a spread mode state of an aerosol generating device according to an embodiment.

FIG. 3 is a diagram illustrating a rolling mode state of an aerosol generating device according to an embodiment.

FIG. 4 is a diagram illustrating an aerosol generating system in which an aerosol generating article is accommodated in a rolling mode state of an aerosol generating device according to an embodiment.

FIGS. 5a and 5b are plan views of a state in which an aerosol generating article is not inserted into an aerosol generating device according to an embodiment.

FIG. 6 is a diagram illustrating a state in which a cover part is taken off in a spread mode state of an aerosol generating device according to an embodiment.

### BEST MODE FOR CARRYING OUT THE INVENTION

The terms used to describe the embodiments are selected from among common terms that are currently widely used, in consideration of their function in the disclosure. However, different terms may be used depending on an intention of one of ordinary skill in the art, a precedent, or the advent of new technology. Also, in particular cases, the terms are arbitrarily selected by the applicant of the disclosure, and the meaning of those terms will be described in detail in the corresponding part of the detailed description. Therefore, the terms used to describe the disclosure should be defined based on the meanings of the terms and all the content of the disclosure, rather than the terms themselves.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and which may be implemented as hardware, software, or a combination of hardware and software.

As used herein, an expression such as “at least one of” that precedes listed components modifies not each of the listed components but all the listed components. For example, the expression “at least one of a, b, or c” should be construed as including a, b, c, a and b, a and c, b and c, or a, b, and c.

In following descriptions of embodiments, the term “aerosol generating article” may refer to an article that accommodates a medium in which an aerosol passes through the article and the medium is transferred. A representative example of the aerosol generating article may be a cigarette. However, the scope of the disclosure is not limited thereto.

In following descriptions of embodiments, the terms “upstream” or “upstream direction” may refer to a direction away from a mouth of a user (smoker), and the terms “downstream” or “downstream direction” may refer to a direction toward the mouth of the user. The terms “upstream” and “downstream” may be used to describe relative positions of components of the aerosol generating article.

In following descriptions of embodiments, the term “puff” may refer to inhalation by the user, in a situation in which an aerosol is sucked into the mouth, nose, or lungs of the user through the mouth or nose of the user.

In an embodiment, an aerosol generating device may be a device that generates an aerosol by electrically heating an aerosol generating article accommodated in an inner space.

The aerosol generating device may include a heater. In an embodiment, the heater may be an electrically resistive heater. For example, the heater may include an electrically conductive track, and the heater may be heated as a current flows through the electrically conductive track.

The heater may include a tubular heating element, a plate-shaped heating element, a needle-shaped heating element, or a rod-shaped heating element, and may heat the inside or outside of the aerosol generating article according to the shape of a heating element.

The aerosol generating article may include a tobacco rod and a filter rod. The tobacco rod may be formed as a sheet or a strand, or may be formed of tobacco leaves finely cut from a tobacco sheet. In addition, the tobacco rod may be enveloped by a thermally conductive material. For example, the thermally conductive material may be a metal foil such as aluminum foil. However, embodiments are not limited thereto.

The filter rod may be a cellulose acetate filter. The filter rod may include at least one segment. For example, the filter rod may include a first segment that cools an aerosol and a second segment that filters a predetermined ingredient contained in the aerosol.

In another embodiment, the aerosol generating device may be a device that generates an aerosol using a cartridge containing an aerosol generating material.

The aerosol generating device may include a cartridge containing the aerosol generating material and a main body supporting the cartridge. The cartridge may be detachably coupled to the main body. However, embodiments are not limited thereto. The cartridge may be integrally formed or assembled with the main body, and may be secured to the main body so as not to be detached by a user. The cartridge may be mounted on the main body while the aerosol generating material is accommodated therein. However, embodiments are not limited thereto. The aerosol generating material may be injected into the cartridge while the cartridge is coupled to the main body.

The cartridge may hold the aerosol generating material in any one of various states, such as a liquid state, a solid state, a gaseous state, and a gel state. The aerosol generating material may include a liquid composition. For example, the liquid composition may be a liquid including a tobacco-containing material having a volatile tobacco flavor ingredient, or a liquid including a non-tobacco material.

The cartridge may be operated by an electrical signal or a wireless signal transmitted from the main body to perform the function of generating an aerosol by converting a phase of the aerosol generating material inside the cartridge to a gaseous phase. The aerosol may refer to a gas in which vaporized particles generated from the aerosol generating material are mixed with air.

In another embodiment, the aerosol generating device may generate an aerosol by heating the liquid composition, and the generated aerosol may pass through the cigarette and be delivered to the user. That is, the aerosol generated from the liquid composition may travel along airflow paths of the aerosol generating device, and the airflow paths may be configured to allow the aerosol to pass through the cigarette and be delivered to the user.

In another embodiment, the aerosol generating device may be a device that generates an aerosol from the aerosol generating material using an ultrasonic vibration manner. In this case, the ultrasonic vibration manner may be a manner of generating an aerosol by atomizing the aerosol generating material with ultrasonic vibration generated by a vibrator.

The aerosol generating device may include a vibrator, and may generate vibration at short intervals through the vibrator to atomize the aerosol generating material. The vibration generated by the vibrator may be ultrasonic vibration, and a frequency band of the ultrasonic vibration may be from about 100 kilohertz (kHz) to about 3.5 megahertz (MHz). However, embodiments are not limited thereto.

The aerosol generating device may further include a wick that absorbs the aerosol generating material. For example, the wick may be disposed to surround at least one area of the vibrator or may be disposed to contact at least one area of the vibrator.

As a voltage (e.g., an alternating voltage) is applied to the vibrator, the vibrator may generate heat and/or ultrasonic vibration, and the heat and/or ultrasonic vibration generated by the vibrator may be transmitted to the aerosol generating material absorbed in the wick. The aerosol generating material absorbed in the wick may be converted into a gas phase by the heat and/or ultrasonic vibration transmitted from the vibrator, and consequently, an aerosol may be generated.

For example, viscosity of the aerosol generating material absorbed in the wick may be lowered by the heat generated by the vibrator, and the aerosol generating material with lowered viscosity may be changed to fine particles by the ultrasonic vibration generated by the vibrator, so that an aerosol may be generated. However, embodiments are not limited thereto.

In another embodiment, the aerosol generating device may be a device that generates an aerosol by heating the aerosol generating article accommodated therein in an induction heating manner.

The aerosol generating device may include a susceptor and a coil. In an embodiment, the coil may apply a magnetic field to the susceptor. As the aerosol generating device supplies power to the coil, a magnetic field may be formed inside the coil. In an embodiment, the susceptor may be a magnetic body that generates heat by an external magnetic field. As the susceptor is positioned inside the coil and generates heat with the magnetic field applied, the aerosol generating article may be heated. Also, optionally, the susceptor may be positioned in the aerosol generating article.

In another embodiment, the aerosol generating device may further include a cradle.

The aerosol generating device and the separate cradle may form a system together. For example, the cradle may be used to charge a battery of the aerosol generating device. Alternatively, a heater may be heated when the cradle and the aerosol generating device are coupled to each other.

Hereinafter, embodiments of the disclosure will be described in detail with reference to the accompanying drawings such that one of ordinary skill in the art may easily practice the disclosure. The disclosure may be practiced in forms that are implementable in the aerosol generating devices according to various embodiments described above or may be embodied and practiced in many different forms and is not limited to the embodiments described herein.

Hereinafter, embodiments of the disclosure will be described in detail with reference to the drawings.

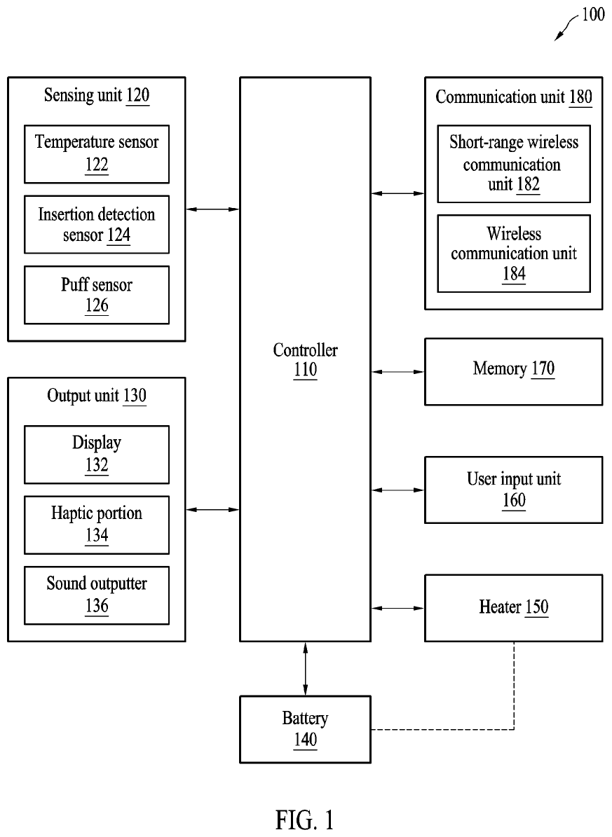

FIG. 1 is a block diagram of an aerosol generating device 100 according to an embodiment.

The aerosol generating device 100 may include a controller 110, a sensing unit 120, an output unit 130, a battery 140, a heater 150, a user input unit 160, a memory 170, and a communication unit 180. However, an internal structure of the aerosol generating device 100 is not limited to what is shown in FIG. 1. It is to be understood by one of ordinary skill in the art to which the disclosure pertains that some of the components shown in FIG. 1 may be omitted or new components may be added according to the design of the aerosol generating device 100.

The sensing unit 120 may sense a state of the aerosol generating device 100 or a state of an environment around the aerosol generating device 100, and transmit sensing information obtained through the sensing to the controller 110. Based on the sensing information, the controller 110 may control the aerosol generating device 100 to control operations of the heater 150, restrict smoking, determine whether an aerosol generating article (e.g., an aerosol generating article, a cartridge, etc.) is inserted, display a notification, and perform other functions.

The sensing unit 120 may include at least one of a temperature sensor 122, an insertion detection sensor 124, or a puff sensor 126. However, embodiments are not limited thereto.

The temperature sensor 122 may sense a temperature at which the heater 150 (or an aerosol generating material) is heated. The aerosol generating device 100 may include a separate temperature sensor for sensing the temperature of the heater 150, or the heater 150 itself may also function as a temperature sensor. Alternatively, the temperature sensor 122 may be arranged around the battery 140 to monitor the temperature of the battery 140.

The insertion detection sensor 124 may sense whether the aerosol generating article is inserted and/or removed. The insertion detection sensor 124 may include, for example, at least one of a film sensor, a pressure sensor, a light sensor, a resistive sensor, a capacitive sensor, an inductive sensor, or an infrared sensor, which may sense a signal change by the insertion and/or removal of the aerosol generating article.

The puff sensor 126 may sense a puff from a user based on various physical changes in an airflow path or airflow channel. For example, the puff sensor 126 may sense the puff from the user based on any one of a temperature change, a flow change, a voltage change, and a pressure change.

The sensing unit 120 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 122 through 126 described above. A function of each sensor may be intuitively inferable from its name by one of ordinary skill in the art, and thus, a more detailed description thereof will be omitted here.

The output unit 130 may output information about the state of the aerosol generating device 100 and provide the information to the user. The output unit 130 may include at least one of a display 132, a haptic portion 134, or a sound outputter 136. However, embodiments are not limited thereto. When the display 132 and a touchpad are provided in a layered structure to form a touchscreen, the display 132 may be used as an input device in addition to an output device.

The display 132 may visually provide information about the aerosol generating device 100 to the user. The information about the aerosol generating device 100 may include, for example, a charging/discharging state of the battery 140 of the aerosol generating device 100, a preheating state of the heater 150, an insertion/removal state of the aerosol generating article, a limited usage state (e.g., an abnormal article detected) of the aerosol generating device 100, or the like, and the display 132 may externally output the information. The display 132 may be, for example, a liquid-crystal display panel (LCD), an organic light-emitting display panel (OLED), or the like. The display 132 may also be in the form of a light-emitting diode (LED) device.

The haptic portion 134 may provide information about the aerosol generating device 100 to the user in a haptic way by converting an electrical signal into a mechanical stimulus or an electrical stimulus. The haptic portion 134 may include, for example, a motor, a piezoelectric element, or an electrical stimulation device.

The sound outputter 136 may provide information about the aerosol generating device 100 to the user in an auditory way. For example, the sound outputter 136 may convert an electric signal into a sound signal and externally output the sound signal.

The battery 140 may supply power to be used to operate the aerosol generating device 100. The battery 140 may supply power to heat the heater 150. In addition, the battery 140 may supply power required for operations of the other components (e.g., the sensing unit 120, the output unit 130, the user input unit 160, the memory 170, and the communication unit 180) included in the aerosol generating device 100. The battery 140 may be a rechargeable battery or a disposable battery. The battery 140 may be, for example, a lithium polymer (LiPoly) battery. However, embodiments are not limited thereto.

The heater 150 may receive power from the battery 140 to heat the aerosol generating material. Although not shown in FIG. 1, the aerosol generating device 100 may further include a power conversion circuit (e.g., a direct current (DC)-to-DC (DC/DC) converter) that converts power of the battery 140 and supplies the power to the heater 150. In addition, when the aerosol generating device 100 generates an aerosol by induction heating, the aerosol generating device 100 may further include a DC-to-alternating current (AC) (DC/AC) converter that converts DC power of the battery 140 into AC power.

The controller 110, the sensing unit 120, the output unit 130, the user input unit 160, the memory 170, and the communication unit 180 may receive power from the battery 140 to perform functions. Although not shown in FIG. 1, the aerosol generating device 100 may further include a power conversion circuit, for example, a low dropout (LDO) circuit or a voltage regulator circuit, which converts power of the battery 140 and supplies the power to respective components.

In an embodiment, the heater 150 may be formed of a predetermined electrically resistive material that is suitable. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 150 may be implemented as a metal heating wire, a metal heating plate on which an electrically conductive track is arranged, a ceramic heating element, or the like, but is not limited thereto.

In another embodiment, the heater 150 may be an induction heater. For example, the heater 150 may include a susceptor that heats the aerosol generating material by generating heat through a magnetic field applied by a coil.

In an embodiment, the heater 150 may include a plurality of heaters. For example, the heater 150 may include a first heater for heating the aerosol generating article and a second heater for heating a liquid.

The user input unit 160 may receive information input from the user or may output information to the user. For example, the user input unit 160 may include a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. In addition, although not shown in FIG. 1, the aerosol generating device 100 may further include a connection interface such as a universal serial bus (USB) interface, and may be connected to another external device through the connection interface such as a USB interface to transmit and receive information or to charge the battery 140.

The memory 170, which is hardware for storing various pieces of data processed in the aerosol generating device 100, may store data processed by the controller 110 and data to be processed thereby. The memory 170 may include at least one type of storage medium of a flash memory type memory, a hard disk type memory, a multimedia card micro type memory, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 170 may store an operating time of the aerosol generating device 100, a maximum number of puffs, a current number of puffs, at least one temperature profile, data associated with a smoking pattern of the user, or the like.

The communication unit 180 may include at least one component for communicating with another electronic device. For example, the communication unit 180 may include a short-range wireless communication unit 182 and a wireless communication unit 184.

The short-range wireless communication unit 182 may include a Bluetooth communication unit, a BLE communication unit, a near field communication unit, a wireless area network (WLAN) (wireless fidelity (Wi-Fi)) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

The wireless communicator 184 may include, for example, a cellular network communicator, an Internet communicator, a computer network (e.g., a local area network (LAN) or a wide-area network (WAN)) communicator, or the like. However, example embodiments are not limited thereto. The wireless communication unit 184 may use subscriber information (e.g., international mobile subscriber identity (IMSI)) to identify and authenticate the aerosol generating device 100 in a communication network.

The controller 110 may control the overall operation of the aerosol generating device 100. In an embodiment, the controller 110 may include at least one processor. The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the disclosure pertains that the processor may be implemented in other types of hardware.

The controller 110 may control the temperature of the heater 150 by controlling supply of power from the battery 140 to the heater 150. For example, the controller 110 may control the supply of power by controlling switching of a switching element between the battery 140 and the heater 150. In another example, a direct heating circuit may control the supply of power to the heater 150 according to a control command from the controller 110.

The controller 110 may analyze a sensing result obtained by the sensing of the sensing unit 120 and control processes to be performed thereafter. For example, the controller 110 may control power to be supplied to the heater 150 to start or end an operation of the heater 150 based on the sensing result obtained by the sensing unit 120. As another example, the controller 110 may control an amount of power to be supplied to the heater 150 and a time for which the power is to be supplied, such that the heater 150 may be heated up to a predetermined temperature or maintained at a desired temperature, based on the sensing result obtained by the sensing unit 120.

The controller 110 may control the output unit 130 based on the sensing result obtained by the sensing unit 120. For example, when the number of puffs counted through the puff sensor 126 reaches a preset number, the controller 110 may inform the user that the aerosol generating device 100 is ending soon, through at least one of the display 132, the haptic portion 134, or the sound outputter 136.

In an embodiment, the controller 110 may control a power supply time and/or a power supply amount for the heater 150 according to a state of the aerosol generating article sensed by the sensing unit 120. For example, when the aerosol generating article is in an over-humidified state, the controller 110 may control the power supply time for an inductive coil to increase a preheating time, compared to a case where the aerosol generating article is in a general state.

An embodiment may also be implemented in the form of a recording medium including instructions executable by a computer, such as a program module executable by the computer. A computer-readable medium may be any available medium that may be accessed by a computer and includes a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

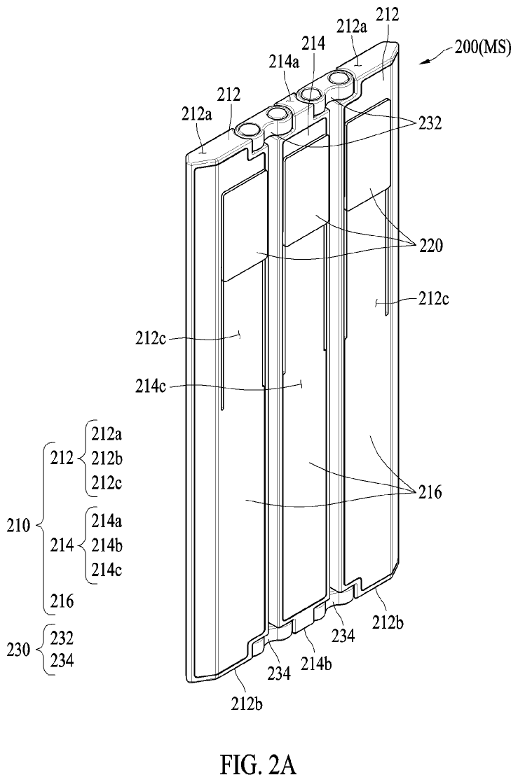

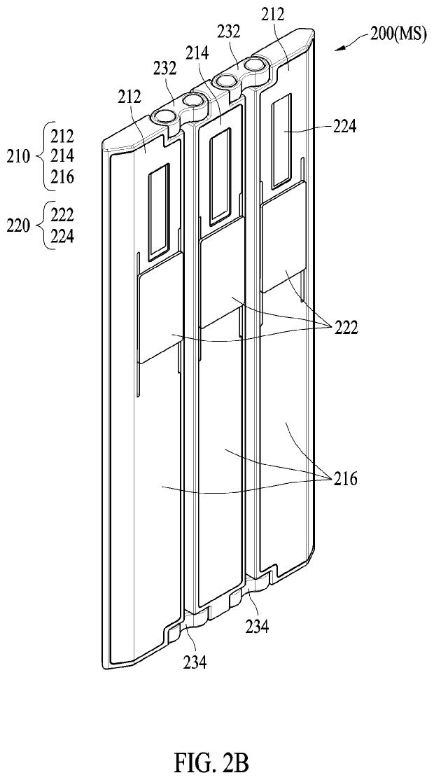

FIGS. 2a and 2b are diagrams illustrating a spread mode state MS of an aerosol generating device 200 according to an embodiment.

Referring to FIGS. 2a and 2b, the aerosol generating device 200 may include a pad unit 210, a heating unit 220, and a hinge unit 230.

The pad unit 210 may be configured to accommodate various electronic/mechanical components, such as the heating unit 220, a battery (not shown), a controller (not shown), and the like.

Referring to FIGS. 2a and 2b again, the aerosol generating device 200 may include a plurality of pad units 210, and desirably, may include an edge pad unit 212 and a center pad unit 214. The edge pad unit 212 may correspond to the pad units 210 disposed at both edges when the plurality of pad units 210 is disposed in parallel. The center pad unit 214 may correspond to at least one pad unit 210 other than the edge pad unit 212. FIGS. 2a and 2b and other following drawings illustrate one center pad unit 214. However, embodiments are not limited thereto, and the aerosol generating device 200 may include two or more center pad units 214.

The edge pad unit 212 and the center pad unit 214 may include first end surfaces 212a and 214a, second end surfaces 212b and 214b respectively formed on opposite sides of the first end surfaces 212a and 214a, front surfaces 212c and 214c formed between the first end surfaces 212a and 214a and the second end surfaces 212b and 214b, and rear surfaces 212d and 214d respectively formed on opposite sides of the front surfaces 212c and 214c. Hereinafter, the direction in which the first end surfaces 212a and 214a are facing will be referred to as an upper direction of the aerosol generating device 200, and the opposite direction of the upper direction (i.e., the direction in which the second end surfaces 212b and 214b are facing) will be referred to as a lower direction of the aerosol generating device 200.

Also, the pad unit 210 may include a pad cover 216. The pad cover 216 may form the front surfaces 212c and 214c of the pad unit 210 and may protect various electronic/mechanical components accommodated in each of the pad units 212 and 214 from an external impact and a foreign material.

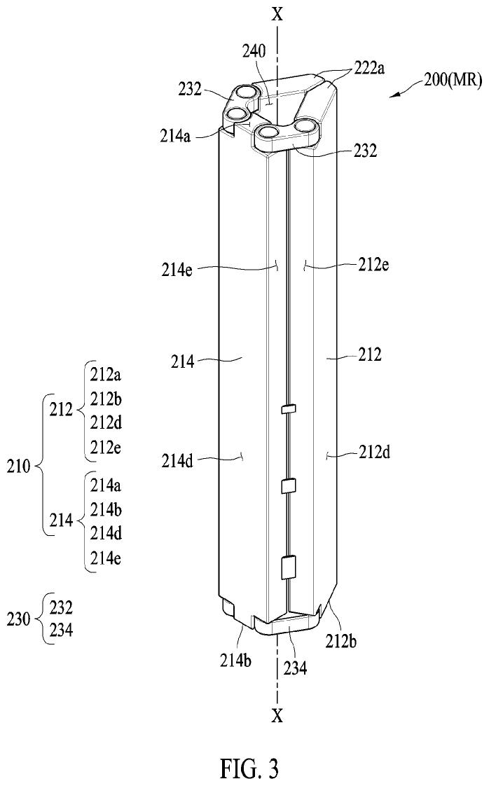

Referring to FIGS. 2a and 2b again, the front surfaces 212c and 214c of the edge pad unit 212 and the center pad unit 214 may be disposed on a plane, and the rear surfaces 212d and 214d of the edge pad unit 212 and the center pad unit 214 may be disposed on another plane parallel to the plane on which the front surfaces 212c and 214c are disposed. The aerosol generating device 200 may be transformed such that the front surfaces 212c and 214c of the plurality of pad units 210 face toward a central axis (e.g., a central axis X-X of FIG. 3). The aerosol generating device 200 is in a spread mode MS when the plurality of pad units 210 are disposed side by side on a plane as shown in FIGS. 2a and 2b, and the aerosol generating device 200 is in a spread mode MS when the front surfaces 212c and 214c of the plurality of pad units 210 are disposed to face toward the central axis X-X as shown in FIG. 3.

Referring to FIGS. 2a and 2b, as the aerosol generating device 200 is activated, a temperature of the heating unit 220 rises, and the heating unit 220 may generate heat. In an embodiment, the heating unit 220 may be disposed on the front surfaces 212c and 214c of the pad units 212 and 214. Desirably, the heating unit 220 may be disposed adjacent to the first end surfaces 212a and 214a of the pad units 212 and 214.

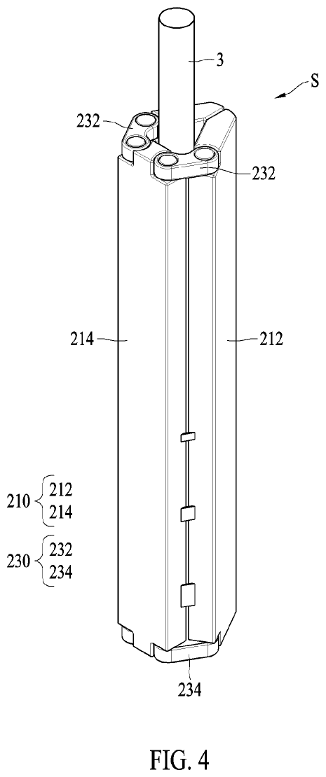

The heating unit 220 may include a cover 224 and a heating portion 222. The cover 224 may be configured to cover and uncover the heating portion 222. The heating portion 222 may generate heat when the aerosol generating device 200 is activated. When the cover 224 is covering the heating portion 222, the aerosol generating device 200 may remain deactivated. The cover 224 may slide up and down on the front surfaces 212c and 214c of the pad unit 210 of the aerosol generating device 200. When an aerosol generating article (e.g., an aerosol generating article 3 of FIG. 4) is inserted into an elongated cavity (e.g., an elongated cavity 240 of FIG. 3) of the aerosol generating device 200, the aerosol generating article 3 may push an end of the cover 224 such that the cover 224 covering the heating portion 222 slides down and uncover the heating portion 222. As a result, the aerosol generating device 200 is activated.

The hinge unit 230 may be disposed between adjacent pad units 210 to connect the edge pad unit 212 to the center pad unit 214 or connect multiple center pad units 214. One or more hinge units 230 may be disposed between adjacent pad units 210. Referring to FIGS. 2a and 2b, the hinge unit 230 may include a first hinge unit 232 and a second hinge unit 234. The number of hinge units 230 is not limited to the embodiment, and one or more additional hinge units 230 may be disposed between the first hinge unit 232 and the second hinge unit 234. The first hinge unit 232 may be disposed parallel to the first end surfaces 212a and 214a of the pad units 212 and 214, and the second hinge unit 234 may be disposed parallel to the second end surfaces 212b and 214b of the pad units 212 and 214.

The hinge unit 230 may allow the aerosol generating device 200 to smoothly transform between the spread mode MS and the rolling mode MR. The hinge unit 230 may be a fixed hinge, a cylinder hinge, a table hinge, a piano hinge, or a combination thereof, but is not limited thereto.

FIG. 3 is a diagram illustrating a rolling mode MR state of the aerosol generating device 200 according to an embodiment.

In an embodiment, the aerosol generating device 200 may be transformed such that both edges of the edge pad unit 212 contact each other. The aerosol generating device 200 may be transformed into the rolling mode MR such that the front surfaces 212c and 214c of the pad units 212 and 214 face toward a central axis X-X. When the aerosol generating device 200 is transformed from the spread mode MS of FIG. 2a into the rolling mode MR of FIG. 3, edges of two edge pad units 212 may contact each other. In this example, the edges of the edge pad units 212 may be coupled in a magnetic coupling manner, a snap-fit coupling manner, an interference fit manner, a snap and sliding manner, and the like. Desirably, the edges of the edge pad units 212 may be coupled in the magnetic coupling manner. However, the coupling of the ends of the edges of the edge pad units 212 is not limited to the above-mentioned coupling manners and may include other coupling manners.

The pad units 212 and 214 may further include side surfaces 212e and 214e formed between the first end surfaces 212a and 214a and the second end surfaces 212b and 214b and between the front surfaces 212c and 214c and the rear surfaces 212d and 214d. The aerosol generating device 200 may be transformed to the rolling mode MR (see FIG. 3) as the side surfaces 212e and 214e of the pad units 212 and 214 move away from each other, while the side surfaces 212e and 214e are disposed adjacent to each other between the respective pad units 212 and 214 in the spread mode MS (see FIG. 2a).

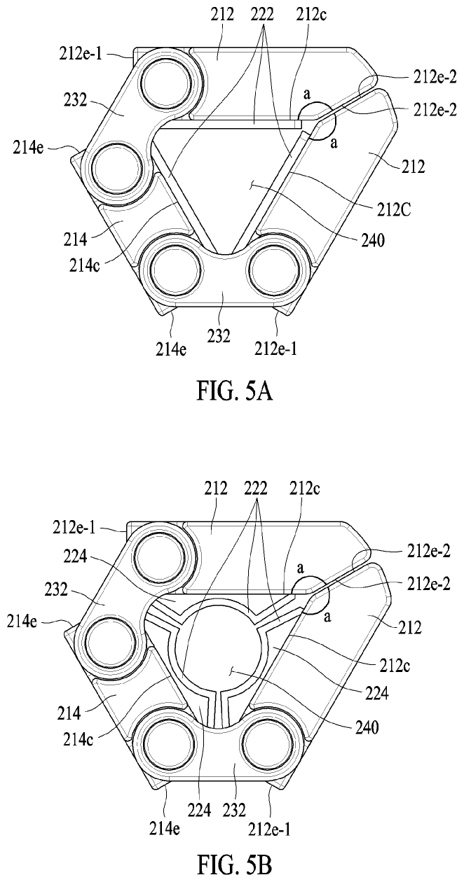

As the aerosol generating device 200 is transformed into the rolling mode MR, the elongated cavity 240 may be formed. The elongated cavity 240 may be a space in which an aerosol generating article is accommodated. The aerosol generating article may be accommodated in the elongated cavity 240 and heated by the heating unit 220 of the aerosol generating device 200. The description related thereto is described in detail with reference to FIGS. 5a and 5b.

FIG. 4 is a diagram illustrating an aerosol generating system S in which the aerosol generating article 3 is accommodated in a rolling mode MR state of the aerosol generating device 200 according to an embodiment.

In the aerosol generating system S, the aerosol generating article 3 may be accommodated in the elongated cavity 240 of the aerosol generating device 200.

When the aerosol generating article 3 is accommodated in the elongated cavity 240 of the aerosol generating device 200, the aerosol generating article 3 may open a cover (e.g., the cover 224 of FIG. 2b) of the heating unit 220 disposed on the front surfaces 212c and 214c of the respective pad units 212 and 214 of the aerosol generating device 200. While being inserted into the elongated cavity 240, the aerosol generating article 3 may push the cover 224 of the heating unit 220 downward and open the cover 224. When the cover 224 of the heating unit 220 opens, the heating portion 222 covered by the cover 224 may be exposed to be disposed on a same plane as the front surfaces 212c and 214c of the pad units 212 and 214. The heating portion 222 may contact the aerosol generating article 3 and heat a medium and other aerosol generating articles disposed in the aerosol generating article 3 such that an aerosol is transmitted to a mouth of a user. Hereinafter, a structure for efficiently heating the aerosol generating article 3 is described in detail with reference to FIGS. 5a and 5b.

FIGS. 5a and 5b are plan views of a state in which the aerosol generating article 3 is not inserted into the aerosol generating device 200 according to various embodiments.

Referring to FIG. 5a, the aerosol generating device 200 may include the elongated cavity 240 having a triangular shape in a rolling mode MR (see FIG. 3). As described above, when the aerosol generating article 3 is inserted into the elongated cavity 240 of the aerosol generating device 200, and the aerosol generating article 3 may push the cover 224 of the heating unit 220 downward and contact the heating portion 222. In this example, the aerosol generating article 3 having a circular cross-section may be heated by linearly contacting each surface of the elongated cavity 240 having a triangular cross-section.

As the number of center pad units 214 of the pad units 210 included in the aerosol generating device 200 increases, the number of angles of the elongated cavity 240 increases in the rolling mode MR. For example, an elongated cavity of an aerosol generating device with two center pad units 214 may have a quadrangular shape, and an elongated cavity of an aerosol generating device with four center pad units 214 may have a hexagonal shape. That is, as the number of center pad units 214 increases, the elongated cavity formed by the aerosol generating device in the rolling mode MR may become closer to a circle. As a result, a contact area of the heating portion 222 and the aerosol generating article 3 inserted into the elongated cavity may increase, and thus, efficient heating may be accomplished.

Referring to FIG. 5b, the aerosol generating device 200 may include the elongated cavity 240 having a circular cross-section in the rolling mode MR (see FIG. 3). According to another embodiment, the cover 224 and the heating portion 222 of a heating unit (e.g., the heating unit 220 of FIG. 2a and/or 2b) may have an arch structure. When the cover 224 and the heating portion 222 have an arch structure, the aerosol generating device 200 may form the elongated cavity 240 having the circular cross-section in the rolling mode MR, as illustrated in FIG. 5b. When the elongated cavity 240 is formed in a circular shape, the heating portion 222 and the aerosol generating article 3 inserted into the elongated cavity 240 may be in surface contact with each other, and thus, more efficient heating may be accomplished.

As shown in FIGS. 5a and 5b, the side surface 212e of the edge pad unit 212 may include a first side surface 212e-1 and a second side surface 212e-2. In an embodiment, the first side surface 212e-1 may correspond to a side surface disposed adjacent to the center pad unit 214, and the second side surface 212e-2 may correspond to a side surface disposed to be spaced apart from the center pad unit 214.

In an embodiment, an angle a between the second side surface 212e-2 and the front surface 212c of the edge pad unit 212 may correspond to an obtuse angle ranging from 90 degrees to 180 degrees. In this case, the second side surfaces 212e-2 may be in close contact with each other in the rolling mode MR, as illustrated in FIGS. 5a and/or 5b. Two angles a, each formed by the second side surface 212e-2 and the front surface 212c of the edge pad unit 212, may be different obtuse angles, but it is desirable that the two angles a are the same, as illustrated in FIGS. 5a and/or 5b. In an embodiment, the angle between the first side surface 212e-1 and the front surface 212c of the edge pad unit 212 and an angle between the side surface 214e and the front surface 214c of the center pad unit 214 may each be 90 degrees, but the embodiments are not limited thereto.

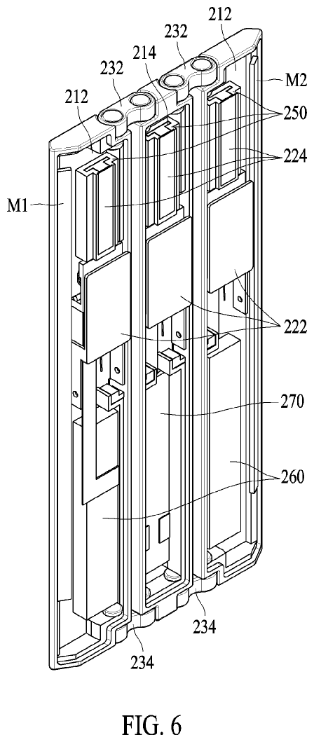

FIG. 6 is a diagram illustrating a state in which a pad cover 216 of the aerosol generating device 200 is taken off according to an embodiment.

Referring to FIG. 6, various electronic/mechanical components may be included in each of the pad units 212 and 214. In an embodiment, magnetic bodies M1 and M2, a heat insulating member 250, a battery 260, and a controller 17 may be included in each of the pad units 212 and 214.

The magnetic bodies M1 and M2 may be disposed on side surfaces of the edge pad unit 212. When the aerosol generating device 200 is in the rolling mode MR (see FIG. 3), edges of the edge pad unit 212 may contact each other. In this example, the edges of the edge pad unit 212 may desirably be coupled in a magnetic coupling manner. The magnetic body M1 disposed on a side surface of the edge pad unit 212 disposed at an end of the aerosol generating device and the magnetic body M2 disposed on a side surface of the edge pad unit 212 disposed at another end of the aerosol generating device may generate an attractive force to be attached, and the aerosol generating device 200 may remain in a rolling mode MR state.

The heat insulating member 250 may prevent heat generated by the heating portion 222 of the heating unit 220 from being transferred to rear surfaces (e.g., the rear surfaces 212d and 214d of FIG. 2b) of the pad units 212 and 214. The heat insulating member 250 may be disposed to enclose at least one surface of the heating portion 222, as illustrated in FIG. 6. Desirably, the heat insulating member 250 may be disposed to enclose at least three of surfaces except for surfaces facing front surfaces (e.g., the front surfaces 212c and 214c of FIG. 2a) of the pad units 212 and 214. More desirably, the heat insulating member 250 may be disposed to enclose all surfaces except for surfaces facing the front surfaces (e.g., the front surfaces 212c and 214c of FIG. 2a) of the pad units 212 and 214. The heat insulating member 250 may increase heating efficiency of the aerosol generating article 3 of the aerosol generating device 200, and thus heat transferred to a gripping portion may decrease when a user uses the aerosol generating device 200.

In an embodiment, the battery 260 may be disposed in at least one of the plurality of pad units 210. When the battery 260 is disposed in only one pad unit of the plurality of pad units 210, a weight of the aerosol generating device 200 may decrease, thereby increasing its portability. When the battery 260 is disposed in two or more pad units of the plurality of pad units 210, a total battery capacity of the aerosol generating device 200 may increase, thereby increasing power efficiency and hours of use.

In an embodiment, the controller 270 may control the overall operation of the aerosol generating device 200. In an embodiment, the controller 270 may include at least one processor. The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the disclosure pertains that the processor may be implemented in other types of hardware. In an embodiment, the controller 270 may be disposed across two or more pad units 210, in which case, the controller 270 may include a flexible printed circuit board (FPCB) to operate smoothly in the spread mode MS and the rolling mode MR of the aerosol generating device 200. In an embodiment, the controller 270 may control the aerosol generating device 200 such that the aerosol generating device 200 remains deactivated in the spread mode MS (see FIG. 2a) and is activated to operate in the rolling mode MR (see FIG. 3).

Although the embodiments have been described with reference to the limited drawings, one of ordinary skill in the art may apply various technical modifications and variations based thereon. For example, suitable results may be achieved if the described techniques are performed in a different order and/or if components in a described system, architecture, device, or circuit are combined in a different manner or replaced or supplemented by other components or their equivalents.

Therefore, other implementations, other embodiments, and equivalents of the claims are within the scope of the following claims.

1. An aerosol generating device, comprising:
a plurality of pad units, each comprising a first end surface, a second end surface formed on an opposite side of the first end surface, a front surface formed between the first end surface and the second end surface, and a rear surface formed on an opposite side of the front surface;
a heating unit disposed on the front surface of each of the plurality of pad units; and
a hinge unit disposed between the plurality of pad units,
wherein the aerosol generating device is transformable such that the front surface of each of the plurality of pad units faces toward a central axis.

2. The aerosol generating device of claim 1, wherein
the aerosol generating device comprises:
a spread mode in which the plurality of pad units are disposed side by side on a same plane; and
a rolling mode in which the front surface of each of the plurality of pad units faces toward the central axis, and
the aerosol generating device is activated in the rolling mode, and the aerosol generating device is deactivated in the spread mode.

3. The aerosol generating device of claim 2, wherein, in the rolling mode, the aerosol generating device forms an elongated cavity configured to accommodate an aerosol generating article as the front surface of each of the plurality of pad units faces toward the central axis.

4. The aerosol generating device of claim 3, wherein
the heating unit comprises:
a heating portion configured to generate heat; and
a cover configured to cover and uncover the heating portion, and
the cover opens as the aerosol generating article is inserted into the elongated cavity.

5. The aerosol generating device of claim 4, wherein
the cover of the heating unit is disposed parallel to the front surface of each of the plurality of pad units, and
the cover opens as the aerosol generating article pushes the cover on the front surface of each of the plurality of pad units while being inserted into the elongated cavity.

6. The aerosol generating device of claim 3, wherein the heating unit has an arch structure such that the elongated cavity has a cylindrical shape in the rolling mode.

7. The aerosol generating device of claim 1, wherein the plurality of pad units each further comprises a side surface formed between the first end surface and the second end surface and between the front surface and the rear surface, and the side surface is disposed to be adjacent to another side surface between the plurality of pad units.

8. The aerosol generating device of claim 7, wherein
the plurality of pad units comprises:
edge pad units respectively disposed at both edges; and
at least one center pad unit disposed between the edge pad units, and
the edge pad units each comprise a magnetic body disposed on the side surface, and the edge pad units are coupled to each other by an attractive force of the magnetic body as the aerosol generating device is transformed such that the front surface of each of the plurality of pad units faces toward the central axis.

9. The aerosol generating device of claim 8, wherein
the side surface of each of the edge pad units comprises:
a first side surface disposed adjacent to the center pad unit; and
a second side surface disposed to be spaced apart from the center pad unit, and an angle between the second side surface and the front surface is an obtuse angle.

10. The aerosol generating device of claim 9, wherein
the magnetic body is disposed on the second side surface of each of the edge pad units, and
the two edge pad units are coupled to each other by the attractive force of the magnetic body in a rolling mode in which the aerosol generating device is transformed such that the front surface of each of the plurality of pad units faces toward the central axis.

11. The aerosol generating device of claim 1, further comprising:
a battery disposed in at least one of the plurality of pad units and configured to supply power to the aerosol generating device.

12. The aerosol generating device of claim 1, further comprising:
a heat insulating member disposed adjacent to the rear surface of each of the plurality of pad units,
wherein the heat insulating member prevents heat generated in the heating unit from being transferred to the rear surface of each of the plurality of pad units.

13. The aerosol generating device of claim 1, wherein
the hinge unit is configured to connect the plurality of pad units to each other, and
the hinge unit comprises a first hinge unit disposed parallel to the first end surface of each of the plurality of pad units and a second hinge unit disposed parallel to the second end surface.
